(19) United States
(12) Patent Application Publication
(10) Pub. No.: US 2007/0153032 A1
(43) Pub. Date: Jul. 5, 2007

(54) MICROINJECTION APPARATUS INTEGRATED WITH SIZE DETECTOR

(76) Inventors: CHUNG-CHENG CHOU, Kweishan (TW); William Wang, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/618,962

(22) Filed: Jan. 2, 2007

(30) Foreign Application Priority Data
Jan. 4, 2006 (TW) 095100384

(51) Int. Cl. B41J 2/195

(52) U.S. Cl. 347/7

(57) ABSTRACT

The invention provides a microinjection apparatus for a fluid. The microinjection apparatus includes a substrate, a manifold, a fluid chamber, a dummy chamber, a detecting device, and a pair of parallel conductive plates. The manifold is formed on the substrate and supplies the fluid chamber and the dummy chamber, also formed on the substrate, with the fluid. In addition, the pair of parallel conductive plates are formed on a pair of opposite inner walls of the dummy chamber, and electrically connected to the detecting device. By applying the pair of parallel conductive plates and the detecting device provided in the invention, the size of the fluid chamber and the fluid-filled condition relative to the fluid chamber can be indirectly detected by non-destructive testing. Furthermore, the cost of and the time of testing also can be prominently saved.

### BACKGROUND OF THE INVENTION

1. Field of the Invention

The invention relates to a microinjection apparatus and, more particularly, to a microinjection apparatus integrated with a size detector.

2. Description of the Prior Art

Micro-technology has a revolutionary impact on many technical fields, such as information industry, communication industry, consumer electronic industry, and bio-technology industry. It is also expected to continuously improve the technology in the production and manufacture in these fields. In these kinds of technology, the microfluidic system relates to the designing, constructing, and manufacturing the device and the process regarding operating micro fluid. At present, the microinjection apparatus, which is one of the microfluidic systems generally used, is extensively used in many techniques including ink-jet printer, biochemical testing, drug screening, fuel injection system, chemical synthesis, and so forth.

Although the size of the microinjection apparatus diminishes as technology develops, the structure of the microinjection apparatus is more and more complicated. In particular, the effect of injection, the efficiency of operation, and the lifespan of the microinjection apparatus are all affected by the original design. Therefore, during the manufacturing process of such a sophisticated device, each of its function units, such as a fluid chamber, a manifold, and an orifice, needs to pass through scrutinizing inspection, so as to ensure both the electrical property and the mechanical property complying with the original design, and to further ensure the quality of fluid injection provided in the future.

The traditional destructive testing has to destruct part of the products or even has to stop the manufacturing process, so as to obtain testing statistics. It is very time-consuming and cost-consuming. Therefore, many non-destructive testing are developed to save the cost and the time for testing. However, many non-destructive testing used nowadays need to have additional testing apparatus installed, such as infrared or probe, or it will need to change the original manufacturing process, so they are not able to save more costs.

### SUMMARY OF THE INVENTION

The invention provides a microinjection apparatus integrated with a size detector to detect the size of a fluid chamber, and further, to judge the fluid-filled condition in the fluid chamber. Moreover, the detector of this invention allows non-destructive testing on the microinjection apparatus, and it can comply with the original manufacturing process and material to prominently save on the cost and the time for testing.

According to the first preferred embodiment of this invention, a microinjection apparatus for a fluid includes a substrate, a manifold, at least one fluid chamber, at least one dummy chamber, a detecting device, and at least one pair of parallel conductive plates. The manifold is formed on the substrate for containing the fluid therein and for supplying the fluid to at least one fluid chamber and at least one dummy chamber. The at least one fluid chamber is formed on the substrate, and is in communication with the manifold. Each of the at least one fluid chamber has at least one orifice, where a respective bubble generating device is disposed nearby for generating a bubble in the fluid chamber to eject the fluid when the fluid chamber is filled with the fluid. The at least one dummy chamber is formed on the substrate, and is in communication with the manifold. Each pair of the at least one pair of parallel conductive plates are formed on a pair of opposite inner walls of one of the at least one dummy chamber, and are also electrically connected to the detecting device for detecting an electrical property between the corresponding pair of parallel conductive plates in accordance with a property of the fluid, so as to determine a distance between the corresponding pair of opposite inner walls when the corresponding dummy chamber is filled with the fluid.

According to the second preferred embodiment of this invention, an ink-jet printing system includes at least one ink cartridge. Each of the at least one ink cartridge is equipped with a respective ink-jet chip which includes a substrate, a manifold, a detecting device, and a processing device. The manifold is formed on the substrate for containing an ink therein and for supplying at least one dummy chamber with the ink. The at least one dummy chamber is formed on the substrate, and is in communication with the manifold. One pair of opposite inner walls of each of the at least one dummy chamber provide at least one pair of parallel conductive plates thereon. The detecting device is electrically connected to each pair of parallel conductive plates for detecting an electrical property between the corresponding pair of parallel conductive plates in accordance with a property of the fluid when the corresponding dummy chamber is filled with the ink. The processing device is electrically connected to the detecting device, for detecting the respective ink-filled condition of each of the ink cartridge according to the corresponding detected electrical properties.

The advantage and spirit of the invention may be understood by the following recitations together with the appended drawings.

### BRIEF DESCRIPTION OF THE APPENDED DRAWINGS

FIG. 1 is a schematic diagram of a microinjection apparatus for a fluid, according to a preferred embodiment of the invention.

FIG. 2 is a schematic diagram of the operating theory according to the invention.

FIG. 3A and FIG. 3B are schematic diagrams showing how to measure the volume of a fluid in a dummy chamber, according to an embodiment of the invention.

In FIGS. 4A through 4F, these figures are schematic diagrams of a method for manufacturing a microinjection apparatus for a fluid, according to a preferred embodiment of the invention.

In FIGS. 5A through 5G, these figures are schematic diagrams of a method for manufacturing a microinjection apparatus for a fluid, according to another preferred embodiment of the invention.

In FIGS. 6A through 6G, these figures are schematic diagrams of a method for manufacturing a microinjection apparatus for a fluid, according to another preferred embodiment of the invention.

FIG. 7 is a schematic diagram showing the allocation of the dummy chambers in the microinjection apparatus, according to an embodiment of the invention.

### DETAILED DESCRIPTION OF THE INVENTION

The invention provides a microinjection apparatus and, more particularly, a microinjection apparatus integrated with a size detector. According to this invention, several preferred embodiments are disclosed as follows.

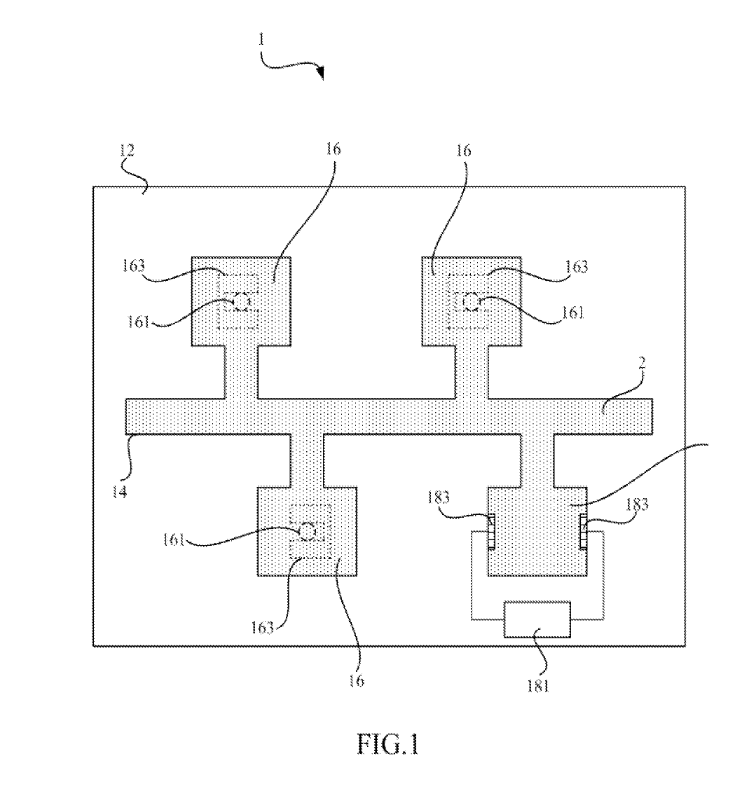

Referring to FIG. 1, FIG. 1 is a schematic diagram of a microinjection apparatus 1 according to a preferred embodiment of the invention. According to this first preferred embodiment, the microinjection apparatus 1 for a fluid 2 includes a substrate 12, a manifold 14, at least one fluid chamber 16, at least one dummy chamber 18, a detecting device 181, and at least one pair of parallel conductive plates 183.

The manifold 14 is formed on the substrate 12, used for containing the fluid 2 therein, and used for supplying the liquid 2 to at least one fluid chamber 16 and at least one dummy chamber 18, which are all formed on the substrate 12 and in communication with the manifold 14. Each of the at least one fluid chamber 16 has at least one orifice 161, where a respective bubble generating device 163 is disposed nearby for generating a bubble in the fluid chamber 16 to eject the fluid 2 when the fluid chamber 16 is filled with the fluid 2. In an embodiment, the fluid chamber 16 and the dummy chamber 18 can be made of a polymer material, such as a photoresist or a dry film. In another embodiment, each dummy chamber 18 does not have any orifice 161 and any bubble generating device 163.

Each pair of the at least one pair of parallel conductive plates 183 are formed on a pair of opposite inner walls of one of the at least one dummy chamber 18, and electrically connected to the detecting device 181 for detecting an electrical property between the corresponding pair of parallel conductive plates 183 according to a property of the fluid 2, so as to determine a distance between the corresponding pair of opposite inner walls when the dummy chamber 18 is filled with the fluid 2.

In an embodiment, the property of the fluid 2 can be a dielectric constant or an electrical conductivity of the fluid 2.

In an embodiment, the electrical property can be a capacitance, an impedance, or a voltage.

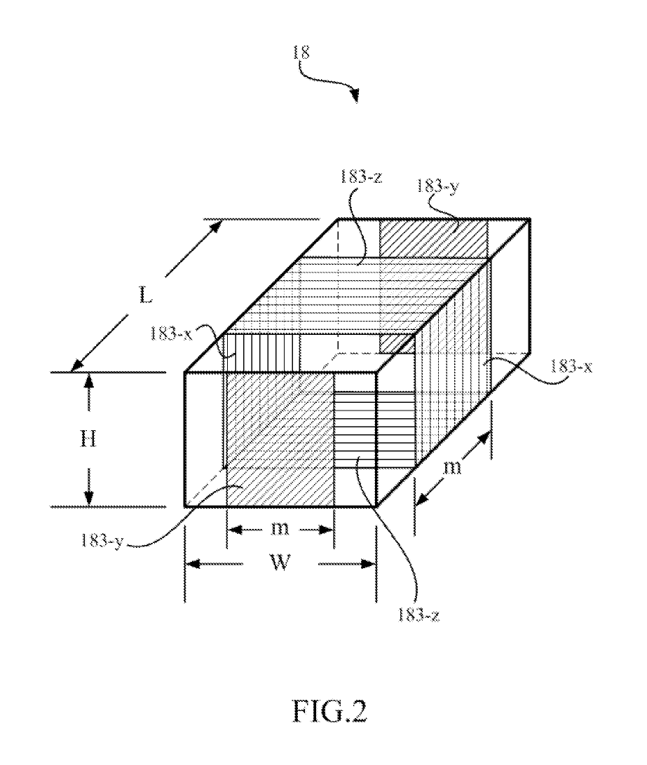

Referring to FIG. 2, FIG. 2 is a diagram illustrating the theory of operation according to the invention. In an embodiment, each of the three pairs of inner walls of a dummy chamber 18 has a pair of parallel conductive plates formed thereon, and the plates are all electrically connected to a detecting device for detecting the volume of the dummy chamber 18. The length, the width, and the height of the dummy chamber 18 are L, W, and H respectively. These three pairs of parallel conductive plates are respectively listed as follows: the first parallel conductive plates 183-x (length H, width m), the second parallel conductive plates 183-y (length H, width m), and the third parallel conductive plates 183-z (length W, width m), wherein m is a known constant. The dummy chamber 18 is filled with the fluid whose dielectric constant is ε. An example of measuring capacitance is represented as follows:

The capacitance between the first parallel conductive plates 183-x can be represented as follows:
Cₓ=εHm/W (1-1)

The capacitance between the second parallel conductive plates 183-y can be represented as follows:
C_{y}=εHm/L (1-2)

The capacitance between the third parallel conductive plates 183-z can also be represented as follows:
C_{z}=εWm/H (1-3)

The following result can be obtained by multiplying Cₓ by C_{z}:
CₓC_{z}=(εm)² (2)

Because m is a known constant, and Cₓ, C_{z} are respectively measured capacitance, the dielectric constant ε of the fluid can be figured out:
ε=(CₓC_{z})^{0.5}/m (3)

Therefore, the ratios of the dimensions of the dummy chamber 18 can be obtained by applying the dielectric constant ε to both of the two equations, (1-1) and (1-2).
H/W=Cₓ/(εm) (4-1)
H/L=C_{y}/(εm) (4-2)

If the area of the three pairs of parallel conductive plates in FIG. 2 is changed to match the surface area of the dummy chamber 18 at this time, each value of the three sets of capacitance can be represented as follows:
Cₓ′=εHL/W (5-1)
C_{y}′=εHW/L (5-2)
C_{z}′=εWL/H (5-3)

If the values of these three sets of capacitance are multiplied with each other, the following result can be obtained:
Cₓ′C_{y}′C_{z}′=WLHε³ (6)

At this time, the ratio of the height to the width (H/W) of the dummy chamber 18 in the equation (4-1) and the ratio of the height to length (H/L) of the dummy chamber 18 in the equation (4-2) are applied to the equation above, the height, H, of the dummy chamber 18 can be represented as follows:
H=((Cₓ′C_{y}′C_{z}′CₓC_{y})/(ε⁵m²))^{1/3} (7)

The height, H, of the dummy chamber 18 can be obtained by applying the value of m, the value of each detected capacitance, and the dielectric constant ε obtained in the equation (3) to the equation (7) above. In addition, the width, W, of the dummy chamber 18 can be obtained by applying the value of H to the equation (4-1), and the length, L, can also be obtained by applying the value of H to the equation (4-2). Eventually, those evaluated data will be used to check whether defects existed after fabrication.

In an embodiment, at least two pairs of parallel conductive plates are formed on a pair of inner walls of each of the at least one dummy chamber. The electrical property relative to the at least two pairs of parallel conductive plates is detected by the detecting device and is further processed to judge a fluid-filled condition relative to the dummy chamber. In practice, the fluid-filled condition of the fluid chamber can be indicated by the judged fluid-filled condition relative to the dummy chamber.

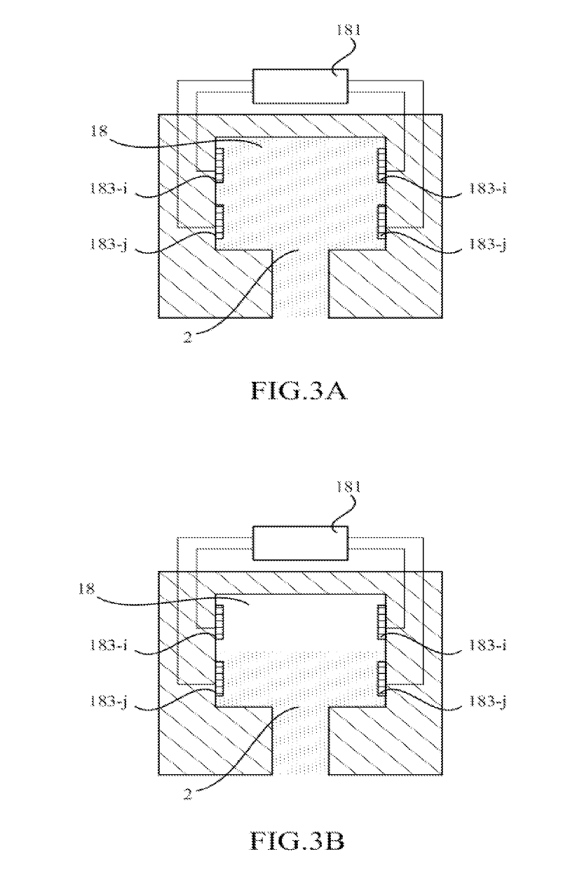

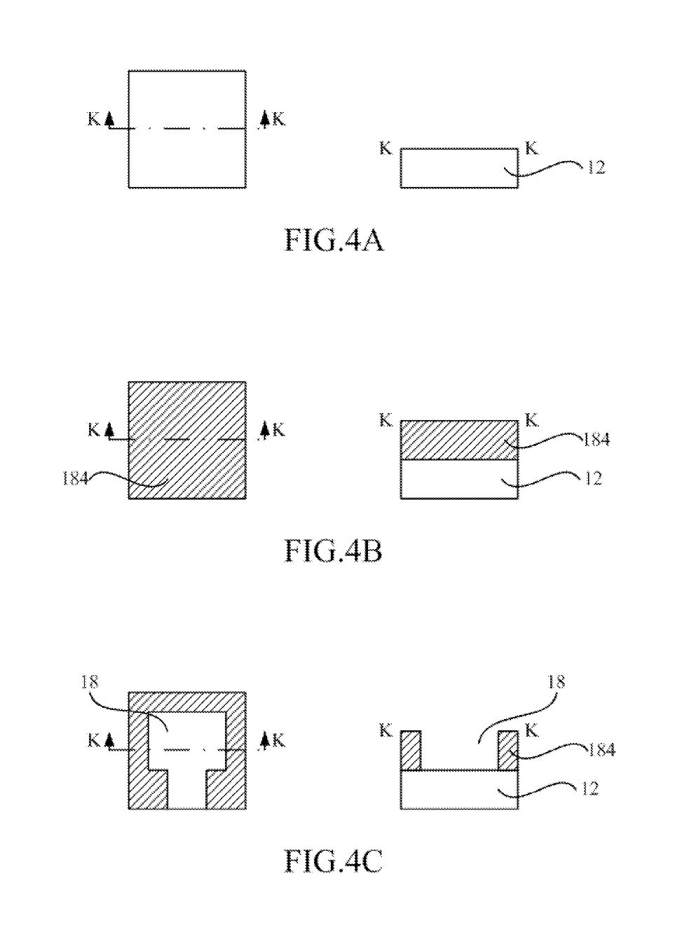

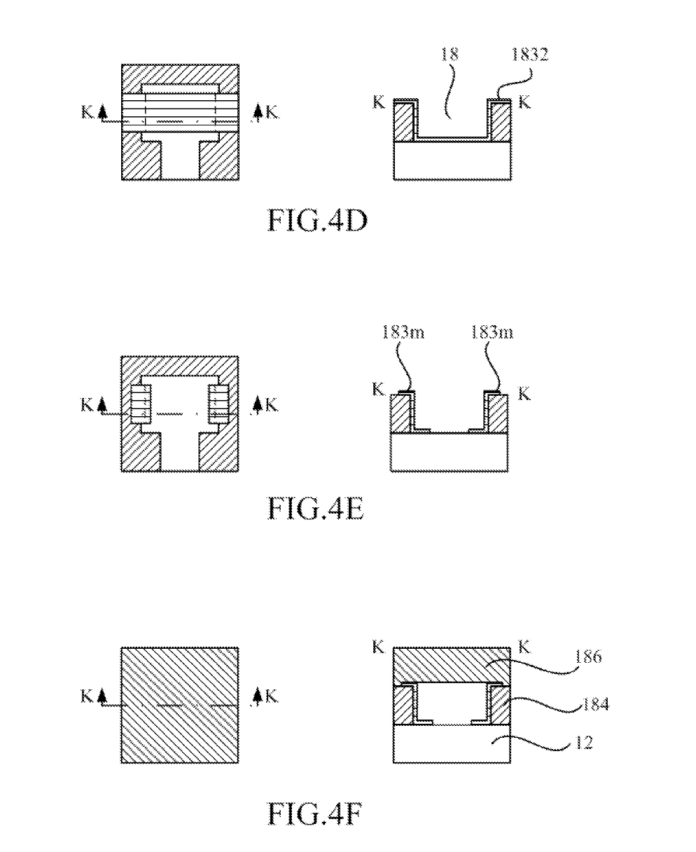

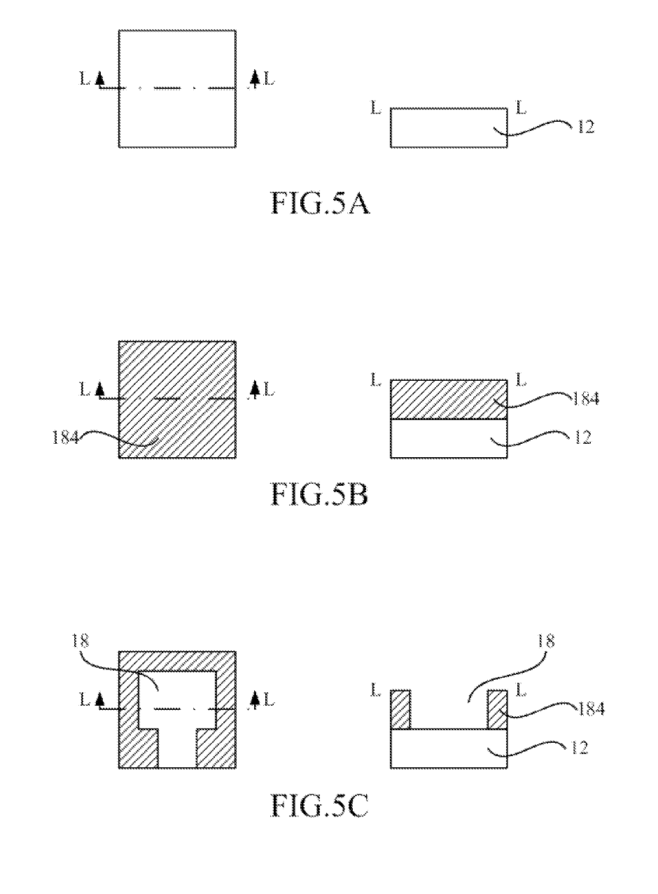

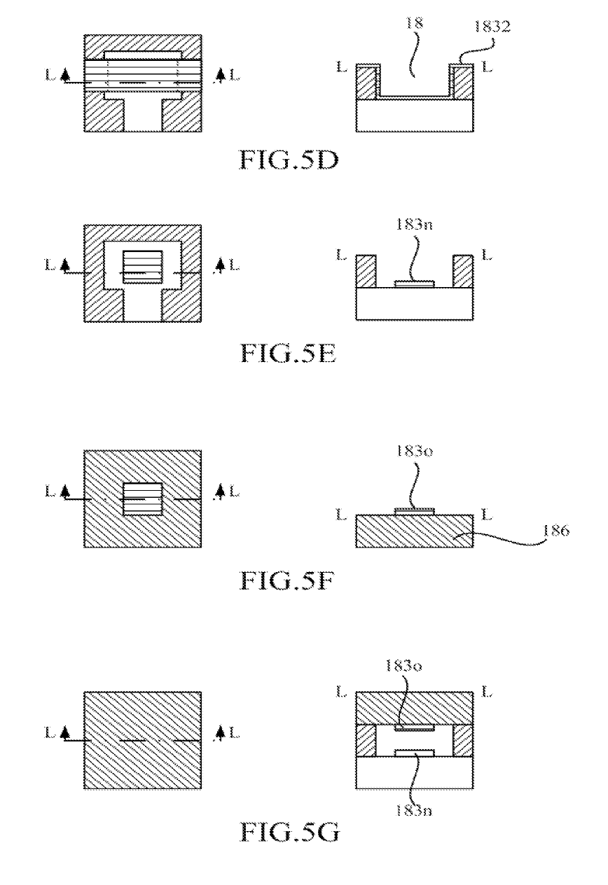

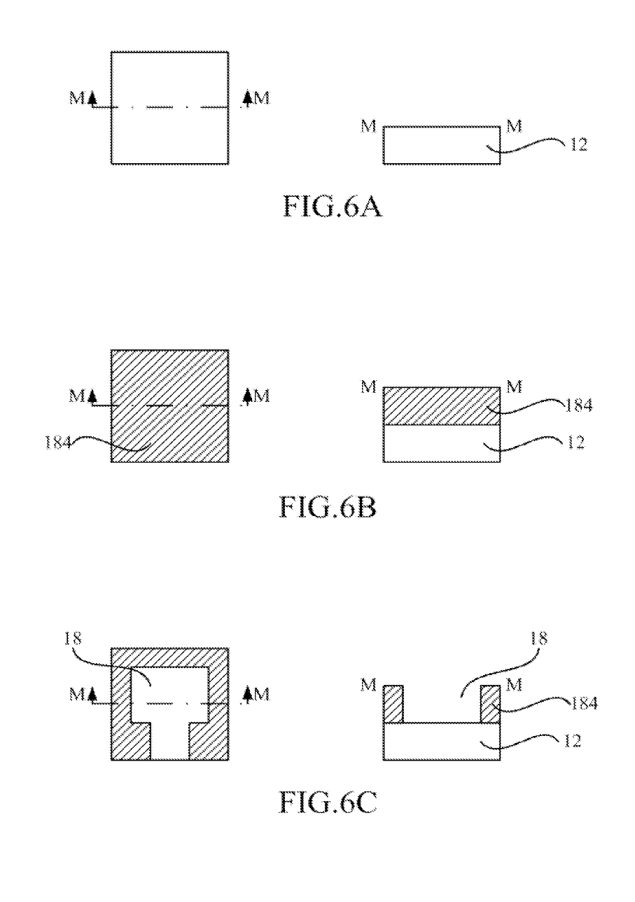

Referring to FIG. 3A and FIG. 3B, in an embodiment, two pairs of parallel conductive plates, 183i (the first parallel conductive plates) and 183j (the second parallel conductive plates), are formed on a pair of opposite inner walls of a dummy chamber 18, and are electrically connected to a detecting device 181. The capacitance relative to the two pairs of parallel conductive plates, 183i and 183j, is detected by the detecting device 181, and is further processed. Moreover, the dummy chamber 18 is also filled with a fluid 2 with a dielectric known constant. When the dummy chamber 18 is filled with the fluid 2, as shown in FIG. 3A, the value of the capacitance measured between the pair of parallel conductive plates, 183i is the same as that between the pair of parallel conductive plates, 183j. On the contrary, as shown in the FIG. 3B, when the volume of the fluid 2 diminishes, there is a void in the dummy chamber 18. Because the fluid 2 and air are substances with different dielectric constants, the values of capacitance between the first parallel conductive plates 183i are different from that between the second parallel conductive plates. This difference is a basis for evaluating the volume of the fluid 2 in the dummy chamber 18.

In an embodiment, the fluid is a liquid, such as ink, a pharmaceutical agent, a biochemical testing agent, a fuel, and so forth.

Referring to FIGS. 4A through 4F, these figures illustrate a method for manufacturing a microinjection apparatus for a fluid, according to a preferred embodiment of the invention. Among these figures, those on the left side are the top views of the microinjection apparatus manufactured in this method. On the other hand, those on the right side are cross-sectional views of the microinjection apparatus manufactured in this method, along the K-K line of their corresponding figures on the left. First, as shown in the FIG. 4A, a substrate 12 is produced. Then, as shown in FIG. 4B, a first polymer material 184 is deposited on the substrate 12. After that, as shown in the FIG. 4C, the polymer material 184 is exposed and developed to form at least one dummy chamber 18. After the dummy chamber 18 is formed, a metal material 1832 is deposited on the bottom and on a pair of inner walls of each of the at least one dummy chamber 18, as shown in FIG. 4D.

Then, as shown in FIG. 4E, by etching the metal material 1832, at least one pair of parallel conductive plates 183m are formed on the corresponding pair of inner walls of each of the at least one dummy chamber 18. The at least one pair of parallel plates 183m are electrically connected to a detecting device (not illustrated in the figures), for detecting an electrical property between the corresponding pair of parallel conductive plates 183m in accordance with a property of the fluid, so as to determine a distance between the corresponding pair of opposite inner walls when the dummy chamber 18 is filled with the fluid. Finally, as shown in FIG. 4F, the top of each of the at least one dummy chamber is covered with a slice of the second polymer material 186, or silicon layer, or glass layer, or metal layer which is isolated to parallel plates 183m, to form a roof for each of the at least one dummy chamber, thus forming the microinjection apparatus.

Referring to FIGS. 5A through 5G, these figures illustrate a method for manufacturing a microinjection apparatus for a fluid, according to a preferred embodiment of the invention. Among these figures, those on the left side are the top views of the microinjection apparatus manufactured in this method. On the other hand, those on the right side are cross-sectional views of the microinjection apparatus manufactured in this method, along the L-L line of their corresponding figures on the left. As shown in FIGS. 5A through 5D, according to the preferred embodiment, the first four steps in this method for manufacturing the microinjection apparatus are the same as those shown in FIGS. 4A through 4D. Thus, these steps are not repeated herein.

After the first four steps are completed, the first metal material 1832 is etched to form at least one first conductive plate 183n on the bottom of each of the at least one dummy chamber 18, as shown in FIG. 5E. Then, as shown in the FIG. 5F, a second metal material is deposited and etched on the surface of a slice of a second polymer material 186 to form at least one second conductive plate 183o on the surface of the slice of the second polymer material 186. Finally, as shown in FIG. 5G, the top of each of the at least one dummy chamber 18 is covered with the slice of the second polymer material 186 to form a roof for each of the at least one dummy chamber 18, thus forming the microinjection apparatus. Again, the second polymer layer 186 for roof of dummy chamber can be replaced by silicon, glass, or metal with isolation surface.

It is worth noting that the surface of the second polymer material 186, which has at least one second conductive plate 183o, faces the dummy chamber 18, resulting in the at least one second conductive plate 183o of the roof being opposite to the at least one first conductive plate 183n of the bottom of the dummy chamber; therefore, at least one pair of parallel conductive plates are formed. The at least one pair of parallel conductive plates are also electrically connected to a detecting device for detecting an electrical property between the corresponding pair of parallel conductive plates in accordance with a property of the fluid, so as to determine a distance between the corresponding pair of opposite inner walls when the dummy chamber 18 is filled with the fluid.

Referring to FIGS. 6A through 6G, these figures illustrate a method for manufacturing a microinjection apparatus for a fluid, according to a preferred embodiment of the invention. Among these figures, those on the left side are the top views of the microinjection apparatus manufactured in this method. On the other hand, those on the right side are cross-sectional views of the microinjection apparatus manufactured in this method, along the M-M line of their corresponding figures on the left. As shown in FIGS. 6A through 6D, according to the preferred embodiment, the first four steps in the method for manufacturing the microinjection apparatus are the same as those shown in FIGS. 5A through 5D. Thus, these steps are not repeated herein

After the first four steps are completed, as shown in FIG. 6E, the first metal material 1832 is etched to form at least one first conductive plate 183p on the pair of opposite inner walls of each of the at least one dummy chamber 18, and at least one second conductive plate 183q is also formed on the bottom of each of the at least one dummy chamber. Then, as shown in FIG. 6F, a second metal material is deposited and etched on the surface of a slice of a second polymer material 186 to form at least a third conductive plate 183r on the surface of the slice of the second polymer material 186.

Finally, as shown in FIG. 6G, the top of each of the at least one dummy chamber 18 is covered with the slice of the second polymer material 186 to form a roof for each of the at least one dummy chamber 18, and further to form the microinjection apparatus. It is worth noting that the surface of the second polymer material 186, which has at least one third conductive plate 183r, faces the dummy chamber, resulting in the at least one third conductive plate 183r of the roof being opposite to the at least one second conductive plate 183q of the bottom of the dummy chamber; therefore, at least one pair of second parallel conductive plates are formed.

Similarly, the at least one pair of the first parallel conductive plates 183p and the at least one pair of the second parallel plates are electrically connected to a detecting device for detecting an electrical property between the corresponding pair of parallel conductive plates in accordance with a property of the fluid, so as to determine a distance between the corresponding pair of opposite inner walls when the corresponding dummy chamber is filled with the fluid.

In an embodiment, applied in the method for manufacturing the microinjection apparatus for a fluid, the aforementioned fluid is an ink. Moreover, the property of the fluid can be represented by a dielectric constant or an electrical conductivity of the fluid.

In an embodiment, the electrical property can be a capacitance, an impedance, or a voltage.

In an embodiment, at least two pairs of parallel conductive plates are formed on a pair of opposite inner walls of each of the at least one dummy chamber. The electrical property relative to the at least two pairs of parallel conductive plates is detected by the detecting device and is further processed to judge a fluid-filled condition relative to the dummy chamber.

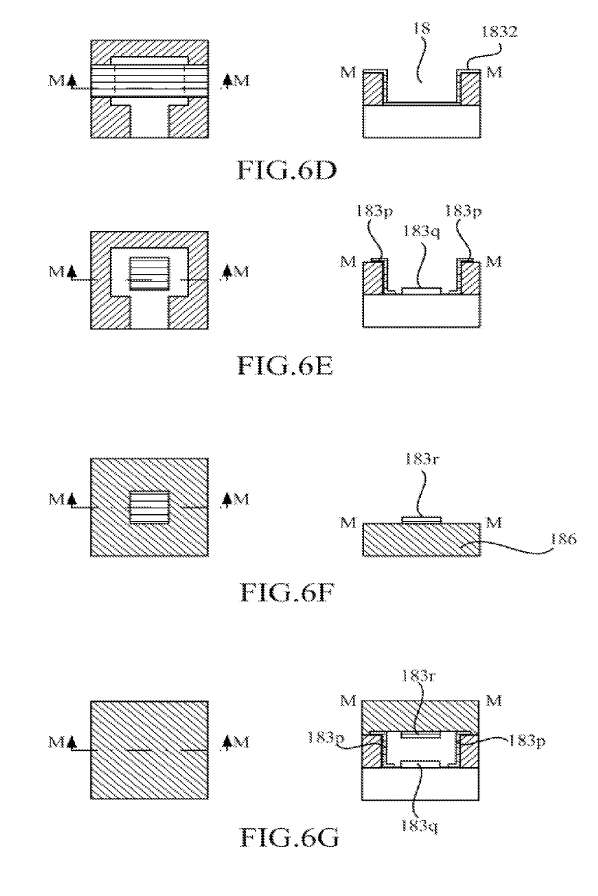

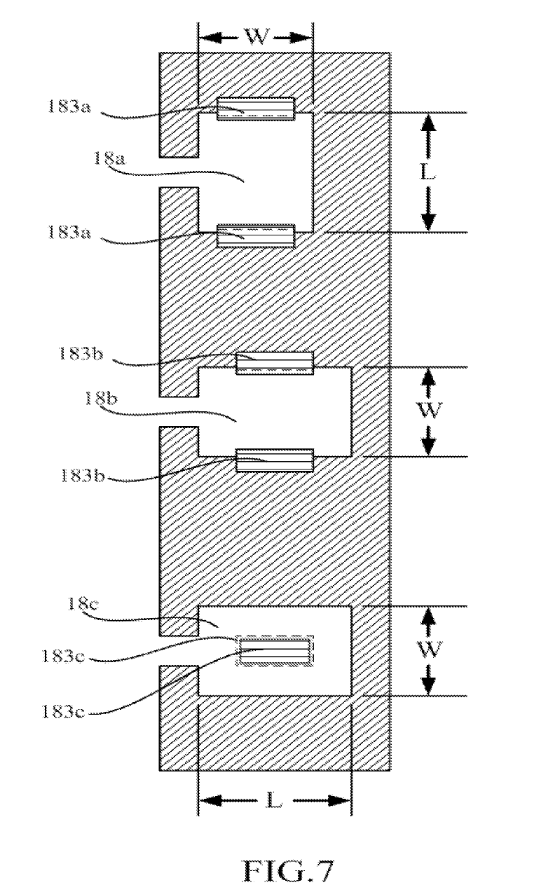

Referring to the embodiment in FIG. 7, when the microinjection apparatus is manufactured, a plurality of dummy chambers can be simultaneously formed in the microinjection apparatus, such as 18a, 18b, and 18c. The volume of each of the three dummy chambers is the same. The parallel conductive plates along the same direction are disposed on the inner walls of the plurality of dummy chambers, for detecting an electrical property between each pair of parallel conductive plates in accordance with a property of the fluid in those dummy chambers, so as to further determine the distance between the pair of opposite inner walls. In addition, the length (L), the width (W), and the height (H) of each of the dummy chambers are also obtained. As shown in FIG. 7, the length (L) can be measured by the parallel conductive plates 183a, and the width (W) can be measured by the parallel conductive plates 183b. In the same way, the height (H) can also be measured by the parallel conductive plates 183c.

According to a preferred embodiment of this invention, an ink-jet printing system includes at least one ink cartridge.

Each of the at least one ink cartridge is equipped with a respective ink-jet chip. Each of the at least one ink-jet chip includes a substrate, a manifold, a detecting device, and a processing device.

The manifold is formed on the substrate for containing an ink therein and for supplying at least one dummy chamber with the ink. The at least one dummy chamber is formed on the substrate and is in communication with the manifold. In addition, a pair of opposite inner walls of each of the at least one dummy chamber thereon provides at least one pair of parallel conductive plates.

The detecting device is electrically connected to each pair of parallel conductive plates, for detecting an electrical property between the corresponding pair of parallel conductive plates in accordance with a property of the fluid when the corresponding dummy chamber is filled with the ink. In an embodiment, the property of the ink is a dielectric constant. On the other hand, the electrical property detected between each pair of parallel conductive plates can be a capacitance, an impedance, or a voltage.

The processing device is electrically connected to the detecting device to determine, for each of the at least one ink cartridge, a respective ink-filled condition relative to the ink cartridge in accordance with the corresponding detected electrical properties.

Obviously, according to this invention, the microinjection apparatus integrated with a size detector can be used to judge the size of a fluid chamber, and further to indirectly judge the fluid-filled condition in the fluid chamber. More particularly, the detector of this invention is allowed to do non-destructive testing on the microinjection apparatus, and it can comply with the original manufacturing process and material to prominently save the cost and the time for testing. Furthermore, according to the ink-jet printing system of this invention, the ink cartridge is equipped with a respective ink-jet chip for indirectly detecting the ink-filled condition relative to the ink cartridge. This set up is not only used in the quality management of manufacturing but also used by consumers to be a basis for changing the ink cartridge.

With the recitations of the preferred embodiments above, the features and spirits of the invention will be hopefully well described, but the scope of the invention will not be constrained. However, the objective is expected to cover all alternative and equivalent arrangements in the scope of the appended claims for which the invention apply.

What is claimed is:

1. A microinjection apparatus for a fluid, comprising:
a substrate;
a manifold, formed on the substrate, for containing the fluid therein;
a fluid chamber, formed on the substrate and in communication with the manifold, the manifold being also for supplying the fluid chamber with the fluid, the fluid chamber having an orifice, where a bubble generating device is disposed nearby, for generating a bubble in the fluid chamber to eject the fluid when the fluid chamber is filled with the fluid;
a dummy chamber, formed on the substrate and in communication with the manifold, the manifold being also for supplying the dummy chamber with the fluid;
a detecting device; and
a pair of first parallel conductive plates, formed on a pair of opposite inner walls of the dummy chamber and electrically connected to the detecting device, the detecting device being for detecting a first electrical property between the pair of first parallel conductive plates in accordance with a property of the fluid to determine a distance between the pair of opposite inner walls when the manifold supplies the dummy chamber with the fluid.

2. The microinjection apparatus of claim 1, wherein the property of the fluid is a dielectric constant or an electrical conductivity of the fluid.

3. The microinjection apparatus of claim 1, wherein the first electrical property is one selected from the group consisting of a capacitance, an impedance, and a voltage.

4. The microinjection apparatus of claim 1, further comprising a pair of second parallel conductive plates, formed on the pair of opposite inner walls of the dummy chamber, wherein the detecting device also detects a second electrical property between the pair of second parallel conductive plates when the dummy chamber is filled with the fluid, and then a fluid-filled condition relative to the dummy chamber is judged according to the first electrical property and the second electrical property.

5. The microinjection apparatus of claim 1, wherein the fluid is an ink.

6. An ink-jet printing system, comprising:
an ink cartridge, equipped with an ink-jet chip, the ink-jet chip comprising:
a substrate;
a manifold, formed on the substrate, for containing an ink therein; and
a dummy chamber, formed on the substrate and in communication with the manifold, the manifold being for supplying the dummy chamber with the ink, a pair of opposite inner walls of the dummy chamber thereon providing at least one pair of parallel conductive plates;
a detecting device, electrically connected to each pair of parallel conductive plates, for detecting an electrical property between said one pair of parallel conductive plates in accordance with a property of the ink when the dummy chamber is filled with the ink; and
a processing device, electrically connected to the detecting device, for judging, for the ink cartridge, an ink-filled condition relative to the ink cartridge in accordance with the detected electrical properties.

7. The ink-jet printing system of claim 6, wherein the property of the ink is a dielectric constant or an electrical conductivity of the ink.

8. The ink-jet printing system of claim 6, wherein the electrical property detected between each pair of parallel conductive plates is one selected from the group consisting of a capacitance, an impedance, and a voltage.
